(19) United States
(12) Patent Application Publication
(10) Pub. No.: US 2009/0005042 A1
(43) Pub. Date: Jan. 1, 2009

(54) METHOD OF BROADCASTING SYSTEM INFORMATION IN COMMUNICATION CELLS FOR HANDOFF

(75) Inventor: Hao BI, Lake Zurich, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/771,025

(22) Filed: Jun. 29, 2007

(51) Int. Cl. H04Q 7/20

(52) U.S. Cl. 455/436

(57) ABSTRACT

A method of operating a network infrastructure entity in which a mobile communication device is capable of handover from a first wireless communication network to a second wireless communication network is described. System information of the second wireless communication network is broadcast, over a control channel of the first wireless communication network, to a plurality of mobile stations communicating with the first wireless communication network. The system information includes a system time of the second wireless communication network measured at a predefined time point of a frame structure of the first wireless communication network and at a transmitter of the first wireless communication network. The system information may further include neighbor cell information and slot offset of control channel.

### FIELD OF THE INVENTION

The invention relates generally to the field of mobile communications and more particularly to handover of a communication session from one air interface to a candidate cell operating according to a different air interface where the mobile station makes measurements of the candidate cell.

### BACKGROUND OF THE INVENTION

Mobile communications systems have become common in metropolitan regions of the world, and are used by a significant number of people for every day personal and business communication activity. Communication service is in such demand that a variety of systems using different protocols and air interfaces have become established and co-exist in many regions. The overlapping coverage of these systems provides people with a choice of operators. Furthermore, the abundance of coverage has allowed operators to partner with each other to offer customers wider coverage on other systems where the operator does not have coverage and other system operators do provide coverage. In addition, smaller systems have, in some places, been merged into other systems.

To take advantage of the variety of systems and coverage available, manufacturers of mobile devices have begun to design mobile devices with transceivers that are capable of operating in accordance with multiple air interfaces. Given that a mobile device can operate on multiple air interfaces, and that system operators can offer service to subscribers on various systems, it is desirable to make handover possible for a call from one system or air interface to another.

The prospect of handing over a call or communication session to a different air interface presents some issues. For example, mobility management becomes more complex as the candidate cell likely operates not only on a different frequency, but on one that is outside the allocated frequency band of the present serving network. Furthermore, the candidate handover cell may operate using a different air interface, having a different framing structure and different modulation. Furthermore, the present serving network may have no timing information regarding the signaling and framing of the candidate handover cell. Consequently, the mobile station must ascertain substantially more information from the candidate handover cell than if the mobile station were handing over to another cell of the present serving network.

In order to acquire the necessary information from the candidate cell, the mobile station must tune away from the present serving cell and listen to the candidate cell. By “tune away” it is meant that the mobile station changes or reconfigures the transceiver to operate in a different band, and may include changing the modulation scheme used. Periodically the mobile station must undertake a measurement of the candidate cell to determine if it remains a candidate cell, or if its rank as a candidate cell changes. Since the candidate cell may have a different time based frame structure, the mobile station may have to tune away from the present serving cell for long periods while it listens for particular information and control symbols.

Tuning away from the present serving cell can be done during discontinuous receive operation, when mobile stops receiving data from present serving cell. That is, the present serving cell only transmits during particular time slots or frames, and during the other time the mobile station may listen to candidate cells. However, tuning away from the present serving cell and listening to candidate cells for long periods until the desired information is received tends to defeat the purpose of discontinuous reception, which is to save power. Furthermore, if the mobile station is engaged in a data session, then tuning away from the present serving cell reduces the reception time. Therefore there is a need for a way to perform the necessary mobility management but minimize or avoid the time away from the present serving cell.

### BRIEF DESCRIPTION OF THE DRAWINGS

FIG. 1 is a system diagram illustrating a mobile communication system having two communication cells with base stations associated with different air interfaces.

FIG. 2 is a state diagram illustrating a type of packet data that may be communicated by transport channels of the mobile communication system of FIG. 1.

FIG. 3 is a state diagram illustrating a frame structure utilized for synchronization of a system time in slots.

FIG. 4 is a state diagram illustrating a control channel cycle that includes a cell/sector specific slot offset of a control channel.

### DETAILED DESCRIPTION OF THE EMBODIMENTS

There is described herein enhancements to a radio access network (RAN) to enable single radio handoff between different air interfaces. The enhancements may be applied, for example, to an Evolved Universal Terrestrial Radio Access Network (E-UTRAN) to enable single radio handoff between the E-UTRAN protocol and another air interface, such as Evolution-Data Optimized (EV-DO) protocol. A single radio architecture provides for utilization of a single radio transmitter and a single radio receiver at a mobile communication device at a given time, regardless of whether the device includes multiple transmitters or receivers. By utilizing one or more of these enhancements, any type of gap in service reception when handing over from a present air interface to a target air interface may be minimized or avoided. One or more enhancements provide a way for an evolved Node B (eNB) to provide assistance for handoff measurements and air interface configuration of connection, session and/or protocol. In particular, neighbor cell information and system time of another network may be announced either through broadcast or dedicated signaling in a present serving cell to perform handoff functions with minimal interruption of mobile reception.

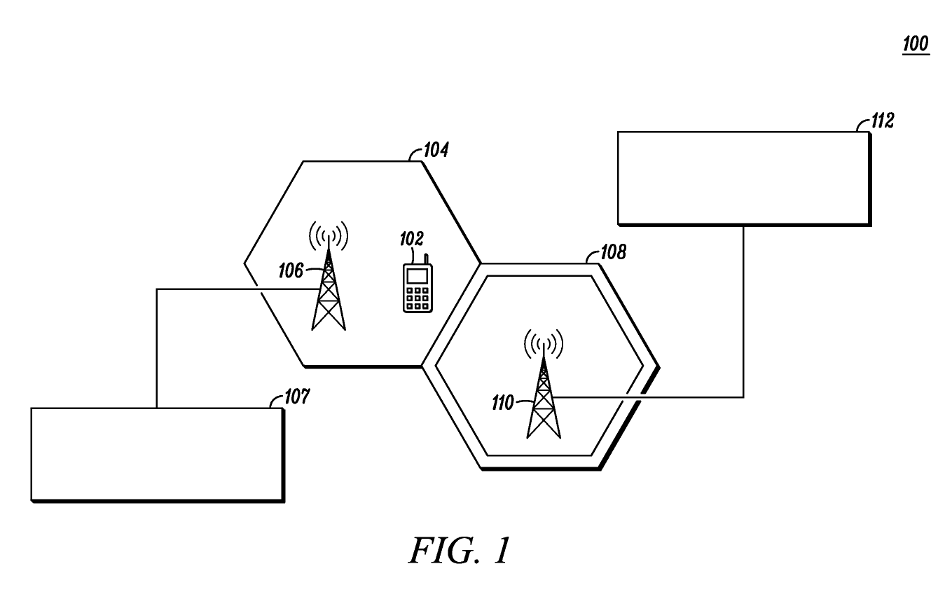

Referring now to FIG. 1, there is shown a mobile communication system 100 including two systems, in accordance with an embodiment of the invention. A mobile communication device 102 is shown operating in a present serving cell 104. The present serving cell 104 is established in the radio vicinity of a base station 106. As used herein, term “cell” may refer to either the geographic area or region in which communication service is provided by a base station, or to the radio interface provided by the base station. Hence, for example, when a mobile device is “connected” to a cell, it is meant that the mobile device is interacting with a base station radio over an established radio interface within the geographic region serviced by the base station. The base station is coupled to a first wireless communications network 107, which may contain the various call processing, switching, and control & administration equipment. The mobile communication device may be any sort of mobile station used for mobile communication, including, for example, cellular telephones, computers, and so on. Neighboring the present serving cell is a candidate handover cell 108. The candidate handover cell is facilitated by a base station 110, which is connected to a second wireless communication network 112. The candidate cell 108 may be operated according to a target radio or air interface different from the present radio or air interface of the present serving cell 104. Furthermore, the candidate cell may be operated on a different frequency than that of the present serving cell.

Although shown here as bordering the present serving cell, it is contemplated that, due to the different air interface and frequency of operation, there may be geographical overlap between the present serving cell and the candidate cell. According to the invention, the mobile communication device 102 may handover communication service to the candidate cell 108 from the present serving cell 104. However, because of the dissimilar air interface, and because the two cells may be operated by different networks, the mobile station faces difficulty in performing mobility management measurements if the mobile station fails to receive sufficient information from the present serving cell regarding the candidate cell.

For example, for one embodiment, handoff from Evolved Universal Terrestrial Radio Access Network (E-UTRAN) to Evolution-Data Optimized (EV-DO) may be supported for the mobile communication device 102 so long as handover related measurements on the EV-DO neighbor cells are performed and EV-DO system information, such as system time is acquired. These tasks of the device 102 may be facilitated by the enhancement of the present invention, since EV-DO system information may be sent in the E-UTRAN cell. The EV-DO system information may include EV-DO neighbor cell information, CDMA system time and slot offset of control channel. For this example embodiment, the TX/RX gaps of E-UTRAN services needed to perform handoff related functions may be minimized to units of about 1 ms.

A degradation of link condition between the mobile communication device 102 and the base station 106 of the first communication network 107 may be detected. In such case, the mobile communication device 102 may initiate the measurements of links between the base station 110 of the second communication network 112 and itself, in accordance with a neighbor cell list of the second communication network provided in advance. The mobile communication devices 102 sends the measurement results to the base station 106 of the first communication network 107. In response, the first communication network 107 may determine whether to handoff from the first communication network 107 to the second communication network 112. If the first communication network 107 determines that a handoff to the second communication network 112 is in order, then it will contact the second communication network (including the base station 110) to request handoff. After receiving a handoff message container from the second communication network 112 (including the base station 110) in response to the request, the first communication network 107 attaches an action time with it and forwards it to the mobile communication device 102 to start the handoff. As a result, the mobile communication device 102 may tune away from the first communication network 107 and tune in to the second communication network 112 at the specified action time.

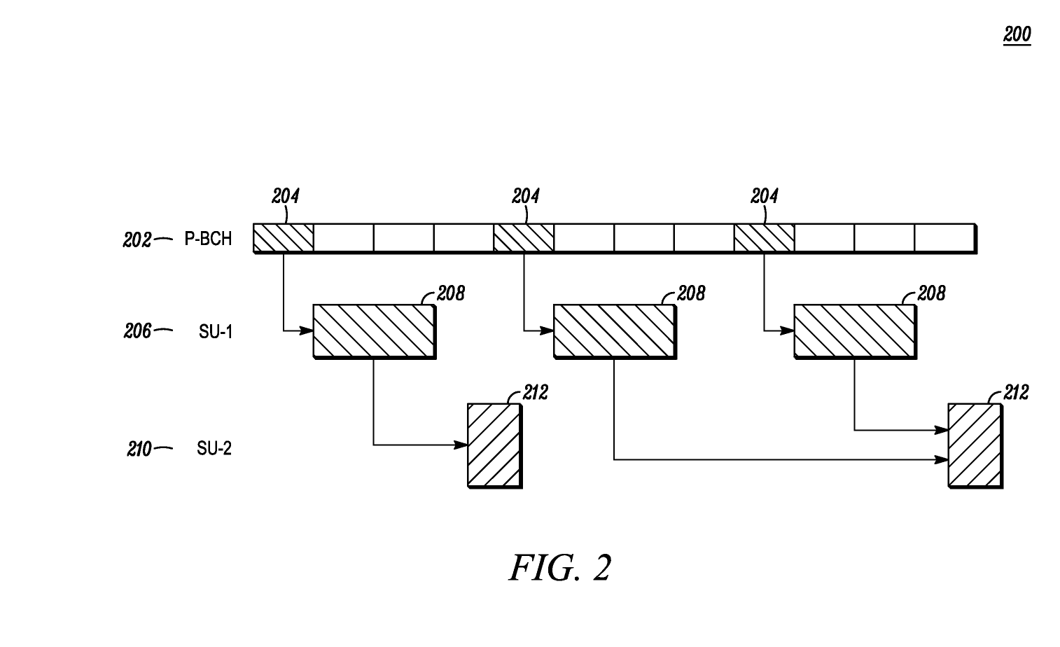

Referring to FIG. 2, system information, including neighbor cell information and system time, of a target air interface may be broadcast by a base station 106 of the first communication network 107, such as an evolved Node B (eNB) associated with 3GPP LTE. In one embodiment, the system information may be transmitted using a broadcast channel, as shown in 200, with a primary broadcast channel and a downlink shared channel, such as DL-SCH, transport channels in E-UTRAN. A limited set of system information may be transmitted using the primary broadcast channel. The primary broadcast channel may have static scheduling, such as periodic transmissions, and transport format, such as certain bandwidth and coding and modulation format. For downlink shared channel, transmission of system information may be flexible and the amount of information possible to convey per subframe depends on the cell bandwidth. The information transmitted on downlink shared channel may be divided based on functionality and timing, such as how often it needs to be transmitted. Therefore, system information blocks (SIBs) can be grouped and transmitted in scheduling units (SU), where the different SUs can be transmitted with different transmission intervals and periods.

For example, for the embodiment 200 illustrated in FIG. 2, the base station 106 of the first communication network 107 may broadcast using a primary broadcast channel 202 including a plurality of broadcast units 204. The primary broadcast channel provides parameters utilized for handover from the present serving cell 104 to the candidate cell 108. The primary broadcast channel may also provide parameters utilized to measure and rank cell re-selection candidates. The primary broadcast channel may reference a first scheduling channel 206. More particularly, each broadcast unit 204 of the primary broadcast channel 202 may reference corresponding first scheduling units 208 of the first scheduling channel 206 that are transmitted at periodic intervals. For example, each of the first scheduling units (SU-1) 208 of the first scheduling channel 206 may be transmitted on a periodic basis, such as every 80 ms. The first scheduling units SU-1 208 may also include parameters utilized for validation of accessibility of a cell re-selection target. In turn, the first scheduling units SU-1 208 may include scheduling information of other scheduling units, so that the mobile communication device 102 may monitor the first scheduling channel 206 for indicators to these other scheduling units. For example, the first scheduling channel 206 may include pointers to the resource blocks associated with a second scheduling channel 210. Thus, the first scheduling units SU-1 208 may be associated with a scheduling block providing the periodicity and resource location for all following scheduling units, such as second scheduling units SU-2 212 of the second scheduling channel 210, and it may also be associated with the mapping of system information blocks into scheduling units, with their sequence numbers or value tags.

The system information of the target network for handoff to the target air interface may include system time and neighbor cell information. A system information block may include the system information and be transmitted in a scheduling unit, such as the second scheduling units SU-2 212 of the second scheduling channel 210. The first scheduling units SU-1 208 may indicate a transmission period (for example, every 80 ms) and a sequence number. Mobile communication devices that perform handoff from the present air interface to the target air interface may, hence, read the first scheduling units SU-1 208 and determine the subframes carrying the scheduling unit with the system information of the target air interface.

Neighbor cell information may be used by a mobile communication device to perform efficient measurement. The neighbor cell information may include the number of neighbor cells/sectors, their frequency band class number, their channel number within the assigned band class, the PN offset of those neighbor cells/sectors, the search window sizes corresponding to those PN offsets, and/or the search window offset corresponding to those PN offsets. Neighbor cell information may assist the mobile communication device to more efficiently search and acquire the pilots of neighbor cells.

The system time of the second communication network 112, such as CDMA System time, may be needed when the mobile communication device 102 listens to the broadcast control channel of a target air interface or performs handoff access to a target air interface, such as an EV-DO system. The present serving cell 104 and the candidate service cell 108 may be asynchronous and may have different frame structures and numerologies, particularly when different air interfaces are utilized by these cells. The system time may be acquired by eNB (evolved node B, such as base station 106) internally through network connections between the first and second networks or through an external source, such as a global positioning system.

In order to broadcast the system time of the second communication network 112 over the base station 106 of the first communication network 107, the system time is measured at a pre-defined time point and put into the scheduling unit carrying the system information of the second communication network 112. For example, the system time of the second communication network 112 may be measured at the beginning of a subframe or some other boundary of the SU carrying the system information of the second communication network 112. Also, since a given signal for determining system time may be received at different time instances at different locations (due to propagation time), the system time must be linked to the location where it is measured. For example, when a system time of the second network is mentioned, i.e., the instance timing related signal is received, it may be measured at a transmitter of a base station of the first network. Once the system time is received, and the mobile communication device determines the time boundaries of frames or slots over the air interface of the second communication network, the mobile communication device may establish the system time of the second communication network at its receiver based on the relative difference between the time boundaries of frames or slots of the first and second communication networks 107, 112.

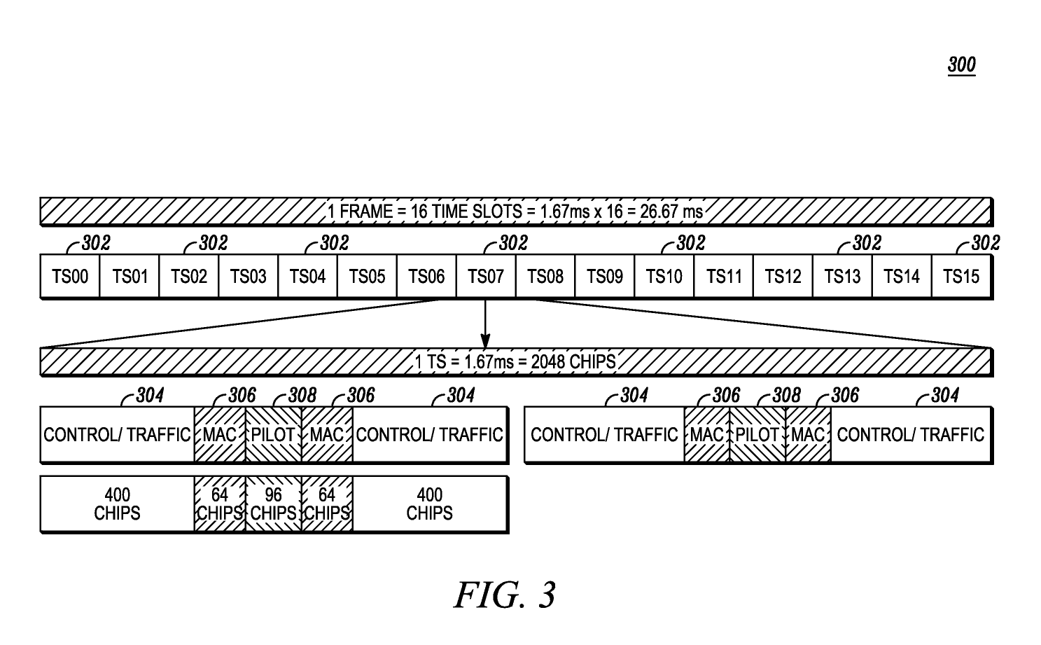

Referring to FIG. 3, there is shown an example embodiment of a communication frame structure 300 of the second communication network 112. For this example, which is an example of an EV-DO forward link frame structure, the communication frame structure includes 16 time slots per frame in which each time slot 402 is about 1.67 ms. Also, each time slot may include control/traffic information 404, media access control (MAC) information 406 and pilot information 408. The EV-DO system time t (in ms), of the second communication network 112, may be measured at the base station of the first communication network 107, at the beginning of the first subframe of the SU of the first communication network carrying EV-DO system information. t is then broadcasted using the SU carrying EV-DO system information. Once t is received, the mobile communication device may convert it into EV-DO system time in slots T=└t×0.6┘. Since the duration of a E-UTRAN subframe is 1 ms, the mobile communication device may track the EV-DO system time in slots for each E-UTRAN subframe.

Furthermore, the mobile communication device may locate the subframes within which reference signals of the second communication network 112, or pilots of EV-DO system in this example, may fall and use related neighbor cell information of the second communication network 112, as those identified above, to search and acquire neighbor cell reference signals of the second communication network 112, or pilots of EV-DO system. By determining the exact location of the reference signals or pilot bursts in this example, and knowing the location of reference signals or pilot bursts in the air interface frames or slots of the second communication network, mobile device can determine the time boundaries of the air interface frames or slots of the second communication network. Knowing the system time of the second communication network at the beginning of a frame of the first communication network received at the mobile device, and the boundary location of the air interface frames or slots of the second communication network, mobile communication device can derive the system time of the second communication network at the boundaries of the air interface frames or slots of the second communication network, by using the time offset of the boundaries of the frames or slots between the first communication network and the second communication network.

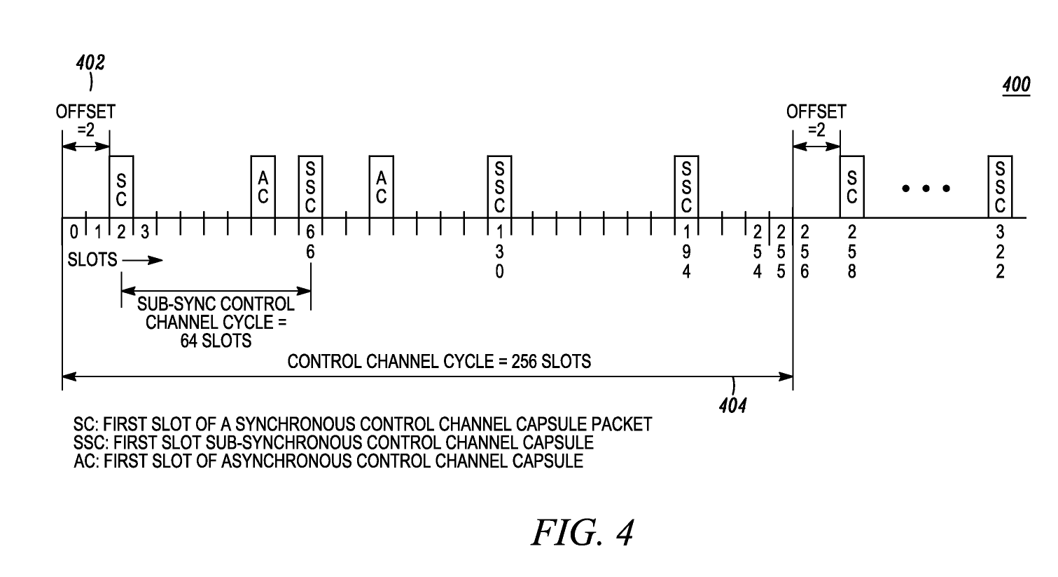

Referring to FIG. 4, there is shown an example of a control channel cycle 400 of the second communication network 112. The cell and/or sector specific slot offset 402 of a control channel 400, such as the EV-DO control channel cycle 404 illustrated in FIG. 4, may be sent in the system information SU of the first communication network. The control channel offset 402 may indicate the slot location of the control channel 400 within a control channel cycle 404, such as the 256-slot control channel cycle shown in FIG. 4. A mobile communication device may tune-in to the control channel 400 of a neighbor cell and/or sector of the second communication network at an appropriate time, based on this information, to monitor overhead messages of the second communication network, such as sync message, sector parameter message, quick configuration message, and the like.

Therefore, system information is essential for a mobile communication device to perform, for example, E-UTRAN to EV-DO handoff measurement and access, so the system information of the second communication network 112 is broadcasted by a base station of the first communication network 107. This enables a single radio mobile communication device to perform handoff-related functions while minimizing any TX/RX gaps of E-UTRAN services.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method of operating a network infrastructure entity in which a mobile communication device is capable of operating with a first wireless communication network, the method comprising:
broadcasting, over a control channel of the first wireless communication network, system information of a second wireless communication network to a plurality of mobile stations communicating with the first wireless communication network, wherein the system information includes a system time of the second wireless communication network measured at a predefined time point of a frame structure of the first wireless communication network and at a transmitter of the first wireless communication network.

2. The method of claim 1, wherein the system time is acquired from a global positioning system.

3. The method of claim 1, wherein the system time placed with a scheduling unit carrying the system information.

4. The method of claim 1, wherein the system information includes neighbor cell information.

5. The method of claim 1, wherein the system information includes slot offset of control channel.

6. The method of claim 1, further comprising instructing the mobile communication device to take measurements of links between the second wireless communication network and the mobile device.

7. A method of operating a mobile communication device capable of operating with a first wireless communication network, the method comprising:
receiving system information of a second wireless communication network over a control channel of the first wireless communication network, wherein the system information includes a system time of the second wireless communication network measured at a predefined time point of a frame structure of the first wireless communication network and at a transmitter of the first wireless communication network.

8. The method of claim 7, wherein the system information includes neighbor cell information.

9. The method of claim 7, wherein the system information includes slot offset of control channel.

10. The method of claim 7, further comprising:
acquiring the second wireless communication network; and
deriving the system time of the second wireless communication network measured at a receiver using the perceived offsets between the frame timings of the first and second wireless communication networks.

11. A method of operating a mobile communication device capable of operating with a first wireless communication network, the method comprising:
receiving system information of a second wireless communication network over a control channel of the first wireless communication network, wherein the system information includes a system time of the second wireless communication network measured at a predefined time point of a frame structure of the first wireless communication network and at a transmitter of the first wireless communication network;
acquiring communication with the second network;
deriving the system time of the second wireless communication network measured at a receiver using offsets between frame timings of the first and second communication networks; and
monitoring a control channel of the second wireless communication network at selected time instances.

12. The method of claim 11, wherein the system information includes neighbor cell information.

13. The method of claim 11, wherein the system information includes slot offset of control channel.

14. The method of claim 11, wherein acquiring communication with the second network includes searching reference signals of the communication using neighbor cell information.

15. The method of claim 11, wherein monitoring a control channel of the second wireless communication network at selected time instances includes tuning in to the second communication network at selected time instances indicated by the slot offset of control channel.
